(19) United States
(12) Patent Application Publication
(10) Pub. No.: US 2013/0243960 A1
(43) Pub. Date: Sep. 19, 2013

(54) WET-ON-WET COATING DEPOSITION PROCESS

(71) Applicant: Nan Wei, East Moline, IL (US)

(72) Inventor: Nan Wei, East Moline, IL (US)

(21) Appl. No.: 13/423,313

(22) Filed: Mar. 19, 2012

(51) Int. Cl. B05D 1/36; C25D 5/10; B05D 1/18; B05D 3/00; B05D 1/38

(52) U.S. Cl. 427/372.2; 205/170

(57) ABSTRACT

A method for coating a substrate includes immersion depositing a first coating layer onto a substrate such that the first coating layer is deposited in a wet state with regard to water and solvents in the first coating layer. While the first coating layer is in the wet state, a second coating layer is immersion deposited onto the first coating layer. The first coating layer and the second coating layer are then co-dried to substantially remove any water and solvents.

### BACKGROUND

This disclosure relates to coating deposition and, more particularly, to the deposition of multiple coating layers on a substrate.

Products that are subject to corrosive, abrasive or other potentially detrimental environmental conditions may be provided with a protective coating. For instance, paint and other organic-based coatings may be used to seal and protect against rusting, abrasion, radiation, biological growth and the like. A typical organic-based coating system may include a primer and a topcoat that is applied over the primer. The primer may serve various functions, such as sealing the underlying substrate, rusting protection and enhancing adhesion between the topcoat and the substrate. The topcoat serves to protect the primer and may also be used to enhance the appearance of the product.

For many commercial products, the organic-based coating deposition process involves applying the primer onto the substrate and then drying and curing the primer prior to applying the topcoat by spray deposition or electrodeposition. After applying the topcoat, the product is dried to cure the topcoat.

### SUMMARY

An example method for coating a substrate according to the present disclosure includes immersion depositing a first coating layer onto a substrate such that the first coating layer is deposited in a wet state with regard to solvents in the first coating layer. While the first coating layer is in the wet state, a second coating layer is immersion deposited onto the first coating layer. The first coating layer and the second coating layer are then co-dried to substantially remove any solvent.

In another aspect, a method for coating a substrate according to the present disclosure includes electrodepositing a primer layer onto a metallic substrate using an aqueous solution such that the primer layer is deposited in a wet state with regard to water in the primer layer. While the primer layer is in the wet state, a topcoat layer is electrodeposited directly onto the primer layer. The primer layer and the topcoat layer are then co-dried to substantially remove any water.

In another aspect, a method for coating a substrate according to the present disclosure includes using an immersion deposition technique to immersion deposit a second coating layer onto a first coating layer. The immersion deposition technique has, with respect to the first coating layer, a thickness-dependent ability to deposit the second coating layer onto the first coating layer. The first coating layer is deposited to have a thickness that permits immersion deposition of the second coating layer onto the first coating layer using the immersion deposition technique.

### BRIEF DESCRIPTION OF THE DRAWINGS

The various features and advantages of the present disclosure will become apparent to those skilled in the art from the following detailed description. The drawings that accompany the detailed description can be briefly described as follows.

FIG. 1 illustrates a method for coating a substrate.

FIG. 2 illustrates a substrate during a deposition process.

FIG. 3 illustrates a process diagram for a method of coating a substrate.

### DETAILED DESCRIPTION OF THE PREFERRED EMBODIMENT

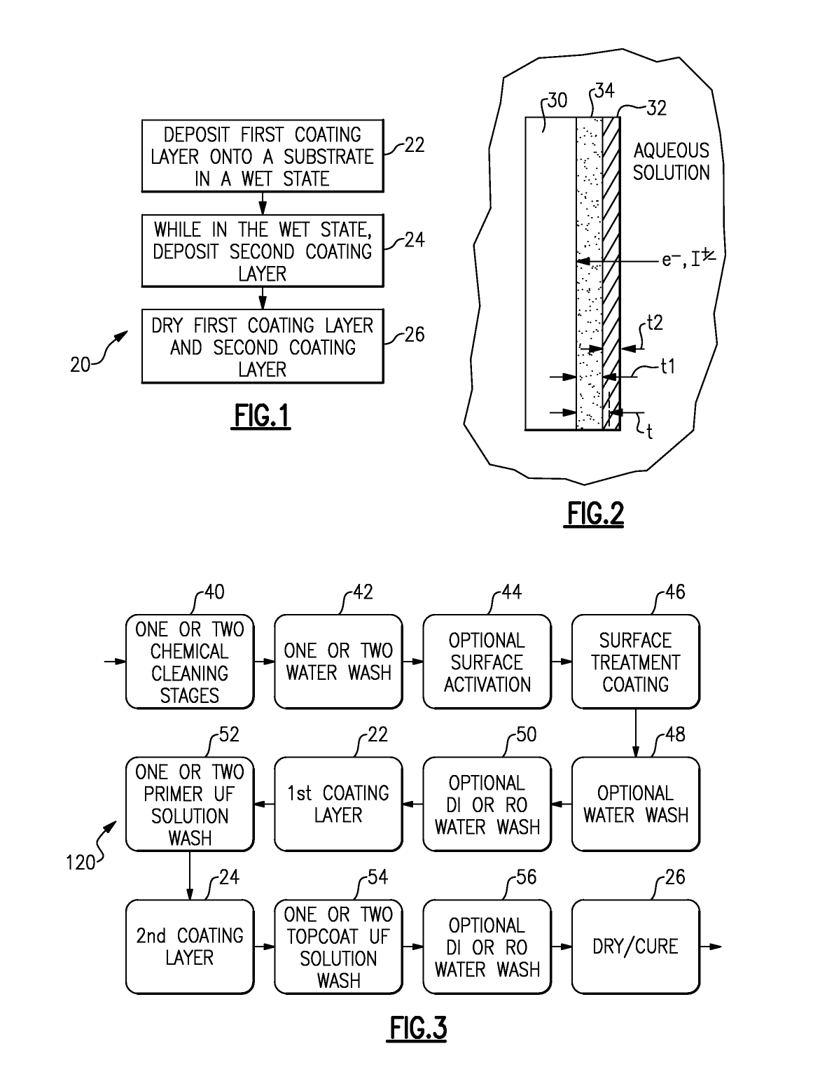

FIG. 1 illustrates a method 20 for coating a substrate. As an example, the method 20 can be utilized to deposit multiple layers of organic-based coatings, such as synthetic or natural resin-based paints, onto a substrate. Non-limiting examples of organic coatings include cements, alkyds, acrylics, vinyl-acrylics, vinyl acetate/ethylene, polyurethanes, polyesters, melamine resins, epoxy, or oils paints.

The method 20 generally includes a first immersion deposition step 22, a second immersion deposition step 24 and a drying step 26, although it is to be understood that the method 20 may also include additional steps. As will be described in further detail below, the second immersion deposition step 24 is conducted while a first coating layer from the first immersion deposition step 22 is still in a wet state. Thus, the method 20 employs a “wet-on-wet” technique and does not utilize an intermediate drying step in between the first immersion deposition step 22 and the second immersion deposition 24. The elimination of the intermediate drying step reduces capital costs and operating costs.

The first immersion deposition step 22 includes depositing the first coating layer onto the substrate such that the first coating layer is deposited in a wet state with regard to any water and solvents in the first coating layer. For example, the first coating layer is saturated with water and solvent in the wet state. While the first coating layer is in the wet state, the second coating layer is deposited onto the first coating layer in the second immersion deposition step 24. As an example, the first coating layer serves as a primer layer and the second coating layer serves as a topcoat layer over the primer layer. In a further example, the second coating layer is deposited directly onto the first coating layer, without any other intermediate layers in between.

The first coating layer and the second coating layer are then co-dried in the drying step 26 to substantially remove (>98%) any solvents therefrom, and optionally also to cure the first coating layer and the second coating layer. The term “co-dried” or variations thereof refers to subjecting the first coating layer and the second coating layer to a single drying step that occurs uninterrupted over a single time period, rather than separate drying steps that occur over time periods that are split by other processing steps.

In a further example, the substrate is a metallic substrate, such as an iron-based alloy, and the first immersion deposition step 22 includes electrodeposition of the first coating layer onto the substrate and the second immersion deposition step 24 includes electrodeposition the second coating layer onto the first coating layer.

In one example, the electrodeposition of the coating layers is conducted using respective aqueous-based emulsion coating materials that, in an applied electric field, deposit onto the substrate. An applied voltage and applied voltage time may be controlled to control the deposited thicknesses of the coating layers. In a further example, the respective aqueous-based emulsions are free of any conductive additives. The aqueous-based emulsions have sufficient inherent conductivity to effect electrodeposition. The general principles of electrodeposition are known are therefore not described in further detail herein, except to note that a layer deposited by electrodeposition includes residual water and solvent from the deposition solution until such water and solvent is removed by forced drying.

The second coating layer is deposited in the second immersion deposition step 22 while the first coating layer is in the wet state with regard to water or solvent in the first coating layer. Instead of removing or substantially removing the water or solvent from the first coating layer prior to the deposition of the second coating layer, the second deposition step 24 is conducted while the first coating layer is in the wet state. That is, the second immersion deposition step 24 is conducted without first subjecting the first coating layer to a drying step. A “drying step” as used herein refers to the process of heating to a temperature above ambient, which for purposes of this disclosure is above approximately 30° C.

In another example, the first immersion deposition step 22 includes autodeposition of the first coating layer and the second immersion deposition step 24 includes autodeposition of the second coating layer. As used herein, “autodeposition” or variations thereof refers to an aqueous, organic coating process that relies on the diffusion of ions to and from the surface of the substrate to drive chemical reactions that result in deposition of a coating layer. The chemical reactions that result in the deposition of the coating layer proceed without the aid of an applied electrical field but depend upon the diffusion of ions to and from the substrate surface.

Autodeposition and electrodeposition are each thickness-dependent immersion deposition techniques that depend upon on the thickness of the first coating layer. The ability of the autodeposition process to deposit the second coating layer depends upon the ability of ions to diffuse through the first coating layer, while the ability of the electrodeposition process to deposit the second coating layer depends upon the conductivity of the first coating layer. In these regards, if the first coating layer has a thickness that exceeds a threshold thickness (t), the first coating layer “self-seals” such that the second coating layer cannot be deposited. Thus, if the first coating layer “self-seals,” there is insufficient ion diffusion to support autodeposition of the second coating layer thereon or, for electrodeposition, there is insufficient conductivity through the first coating layer to support electrodeposition of the second coating layer thereon.

The discovery that immersion deposition can be used to deposit the second coating layer onto the first coating layer while in the wet state, without the use of conductive additives in the first coating layer, enables a reduction in capital equipment. For example, a comparative process may utilize one coating line to electrodeposit and dry a first coating layer and a second coating line to spray-deposit and dry a topcoat layer. The ability, per this disclosure, to immersion deposit the first coating layer and immersion deposit the second coating layer onto the first coating layer while in the wet state enables a coating line to be eliminated by using a single coating line to deposit both the first and second coating layers.

FIG. 2 illustrates an aspect of the method 20 that involves using a thickness-dependent immersion deposition technique, such as electrodeposition or autodeposition, to deposit the second coating layer onto the first coating layer, where the first coating layer is deposited with a thickness (t1) that permits deposition of the second coating layer using the thickness-dependent deposition technique.

In this example, a substrate 30 is shown during immersion deposition of a second coating layer 32 onto a first coating layer 34. The immersion deposition technique used to deposit the second coating layer 32 has, with respect to the first coating layer 34, a thickness-dependent ability to deposit the second coating layer 32 onto the first coating layer 34. In this regard, the first coating layer 34 is deposited with the thickness (t1), which permits deposition of the second coating layer 32 using the deposition technique.

The first coating layer 34 defines a threshold thickness (t), above which the first coating layer 34 does not support immersion deposition of the second coating layer 32. As an example, up to the threshold thickness (t), the first coating layer 34 remains sufficiently conductive (to conduct electrons e⁻ in electrodeposition) or porous (for the diffusion of ions in autodeposition) and thereby permits or supports immersion deposition of the second coating layer 32. In contrast, if the first coating layer 34 were deposited with a thickness that exceeds the threshold thickness t, the first coating layer 34 would not have sufficient conductivity or porosity to support the immersion deposition of the second coating layer 32. Put another way, the coating material that would otherwise form the second coating layer 32 either would not deposit onto the first coating layer 34 or would not completely and uniformly cover the first coating layer 34. Similarly, at a threshold combined thickness of the layers 32 and 34, the layers 32 and 34 will “self-seal” and cease support of further deposition.

In one aspect, the method 20 therefore involves the selection of the deposited thickness (t1) of the first coating layer 34 and a deposited thickness (t2) of the second coating layer 32 to ensure not only that the coating layers 32 and 34 can be deposited as high quality and uniform layers but also that the layers 32 and 34, once dried, are of sufficient thickness to serve the functional protective and aesthetic purposes. To this end, the thicknesses (t2) and (t1) are selected to be within a predetermined ratio of t2/t1 (t2 divided by 0). In one example, the ratio of t2/t1 is from 0.33-4. In a further example, the ratio is 0.66-2, and in a further example, the ratio is 0.66-1.2. The example ratios ensure that the coating layers 32 and 34 can be deposited as high quality and uniform layers and that, once dried, the layers 32 and 34 are of sufficient thickness to serve the functional protective and aesthetic purposes. Further, the ratios also permit tailoring the thicknesses (t1) and (t2) such that minimum thickness values can be determined to minimize weight and amounts of coating materials used.

In a further example, the as-deposited, wet thickness (t1) of the first coating layer 34 is 25-30 micrometers and the as-deposited, wet thickness (t2) of the second coating layer 32 is 10-100 micrometers. In a further example, the as-deposited, wet thickness (t2) of the second coating layer 32 is 20-50 micrometers or 20-30 micrometers.

FIG. 3 illustrates a further example method 120 that involves the first immersion deposition step 22, the second immersion deposition step 24 and the drying step 26, as described above, in combination with additional steps. As shown, the product to be coated is first cleaned in at least one degreasing step 40 that is followed by at least one rinsing step 42. The rinsing step 42 may involve several cycles of rinsing. The product is then subjected to an optional surface activation step 44 and surface treatment coating step 46 before optional an optional water wash step 48 and DI or RO water wash step 50. The product is then subjected to the first immersion deposition step 22 to apply the first coating layer onto the substrate.

Following deposition of the first coating layer, the product is then subjected to at least one additional rinsing step 52 prior to application of the second coating layer in the second deposition step 24. The rinsing step 52 may involve several cycles of rinsing. For example, the rinsing step 52 includes washing the first coating layer using an aqueous solution or fluid, such as a conductive ultrafiltration fluid. The rinsing removes any loose coating material from the first coating layer.

After the rinsing step 52, the product is then subjected to at least one additional rinsing step 54, similar to rinsing step 52, and an optional DI or Ro water wash step 56. The rinsing step 54 may involve several cycles of rinsing. The product is then dried at drying step 26. The drying step 26 may include heating the product with the first coating layer and the second coating layer at an elevated temperature above 30° C. to remove any water or solvent from the layers. The heating may also be used to cure the coating layers. The product may then be cooled and other processing steps may thereafter be conducted as necessary. Each of the steps may be carried out in containers or tanks, for example.

In comparison to methods that utilize spray deposition of the second coating after the electrodeposition of the primer coating, the disclosed method 20/120 that involves the immersion deposition of the second coating layer onto the first coating layer while the first coating layer is in a wet state, and which does not utilize an intermediate drying step in between the first immersion deposition step 22 and the second immersion deposition 24, is simplified and reduces capital cost and energy consumption by eliminating the need for additional labor and drying equipment. The method 20/120 also eliminates spray deposition of organic coatings, which thus reduces volatile organic emissions and waste-water generation.

Although a combination of features is shown in the illustrated examples, not all of them need to be combined to realize the benefits of various embodiments of this disclosure. In other words, a system designed according to an embodiment of this disclosure will not necessarily include all of the features shown in any one of the Figures or all of the portions schematically shown in the Figures. Moreover, selected features of one example embodiment may be combined with selected features of other example embodiments.

The preceding description is exemplary rather than limiting in nature. Variations and modifications to the disclosed examples may become apparent to those skilled in the art that do not necessarily depart from the essence of this disclosure. The scope of legal protection given to this disclosure can only be determined by studying the following claims.

What is claimed is:

1. A method for coating a substrate, the method comprising:
immersion depositing a first coating layer onto a substrate such that the first coating layer is deposited in a wet state with regard to water and solvents in the first coating layer;
while the first coating layer is in the wet state, immersion depositing a second coating layer onto the first coating layer; and
co-drying the first coating layer and the second coating layer to substantially remove any water and solvents therefrom.

2. The method as recited in claim 1, including immersion depositing the first coating layer and the second coating layer using electrodeposition.

3. The method as recited in claim 1, including immersion depositing the first coating layer and the second coating layer using autodeposition.

4. The method as recited in claim 1, wherein the first coating layer and the second coating layer are electrically conductive in the wet state.

5. The method as recited in claim 1, wherein the first coating layer is immersion deposited in the wet state with regard to water and solvent in the first coating layer.

6. The method as recited in claim 1, including rinsing the first coating layer in an aqueous fluid prior to the immersion depositing of the second coating layer.

7. The method as recited in claim 1, including immersion depositing the second coating layer directly onto the first coating layer.

8. The method as recited in claim 1, including immersion depositing the first coating layer and the second coating layer using respective aqueous solutions.

9. The method as recited in claim 1, including using an immersion deposition technique to deposit the second coating layer onto the first coating layer, the immersion deposition technique having, with respect to the first coating layer, a thickness-dependent ability to deposit the second coating layer onto the first coating layer, and immersion depositing the first coating layer with a thickness (t1) that permits immersion deposition of the second coating layer onto the first coating layer using the immersion deposition technique.

10. The method as recited in claim 1, wherein the first coating layer has a first thickness (t1) and the second coating layer has a second thickness (t2) such that a ratio of t2/t1 is 0.33-4.

11. The method as recited in claim 10, wherein the ratio t2/t1 is 0.66-2.

12. The method as recited in claim 10, wherein the ratio t2/t1 is 0.66-1.2.

13. A method for coating a substrate, the method comprising:
electrodepositing a conductive primer layer onto a metallic substrate using an aqueous solution such that the primer layer is deposited in a wet state with regard to water and solvent in the primer layer;
while the conductive primer layer is in the wet state, electrodepositing a topcoat layer directly onto the primer layer; and
co-drying the conductive primer layer and the topcoat layer to substantially remove any water therefrom.

14. The method as recited in claim 13, wherein the conductive primer layer has a first thickness (t1) and the topcoat layer has a second thickness (t2) such that a ratio of t2/t1 is 0.33-4.

15. The method as recited in claim 14, wherein the ratio t2/t1 is 0.66-2.

16. The method as recited in claim 14, wherein the ratio t2/t1 is 0.66-1.2.

17. A method for coating a substrate, the method comprising:
using an immersion deposition technique to immersion deposit a second coating layer onto a first coating layer, the immersion deposition technique having, with respect to the first coating layer, a thickness-dependent ability to deposit the second coating layer onto the first coating layer; and
immersion depositing the first coating layer with a thickness (t1) that permits immersion deposition of the second coating layer onto the first coating layer using the immersion deposition technique.

18. The method as recited in claim 17, wherein the immersion deposition technique is electrodeposition.

19. The method as recited in claim 17, wherein the immersion deposition technique is autodeposition.

20. The method as recited in claim 17, wherein the thickness (t1) is 25-30 micrometers.

21. The method as recited in claim 17, wherein the first coating layer defines a threshold thickness (t) above which the immersion deposition technique is unable to immersion deposit the second coating layer onto the first coating layer.
